(19) United States
(12) Patent Application Publication
(10) Pub. No.: US 2022/0410687 A1
(43) Pub. Date: Dec. 29, 2022

(54) VEHICLE FLOOR LAYER BATTERY WITH AIR VENTILATION

(71) Applicants: Peter J. Tezza II, Oxnard, CA (US); Jean-Thierry Aupetit, Oxnard, CA (US)

(72) Inventors: Peter J. Tezza II, Oxnard, CA (US); Jean-Thierry Aupetit, Oxnard, CA (US)

(21) Appl. No.: 17/851,005

(22) Filed: Jun. 27, 2022

Related U.S. Application Data
(60) Provisional application No. 63/215,931, filed on Jun. 28, 2021.

(51) Int. Cl. B60K 1/04; H01M 50/249; H01M 50/204; H01M 10/625; H01M 10/613; H01M 50/507; H01M 10/6556

(52) U.S. Cl. CPC B60K 1/04; H01M 50/249; H01M 50/204; H01M 10/625; H01M 10/613; H01M 50/507; H01M 10/6556; B60K 2001/0438; H01M 2220/20

(57) ABSTRACT

A thin floor battery layer for a vehicle, the thin floor battery layer comprising: an upper layer; a lower layer; a frame, the frame comprising of: a plurality of pockets; a duct system, including a main duct and a plurality of capillary ducts; a plurality of bus bars; and at least one mounting plate; wherein the frame is between the upper lay and the lower layer; wherein the frame holds a plurality of batteries; wherein the plurality of pockets are underneath the plurality of batteries; and wherein air passes through the duct system via the main duct and into the plurality of capillary ducts that feed the plurality of pockets so as to cool the plurality of batteries.

### CROSS-REFERENCE TO RELATED APPLICATIONS

This application is a non-provisional of, and claims the benefit of priority from, U.S. Provisional Patent Application No. 63/215,931 filed Jun. 28, 2021.

### FEDERALLY SPONSORED REASEARCH

Not Applicable

### FIELD OF INVENTION

This invention relates to a floor layer battery for a vehicle, more particularly, to a floor layer battery for vehicles such as vans, camper vans, and recreational vehicles (RVs).

### BACKGROUND

High-capacity batteries take significant amounts of physical space and need to be kept within a defined temperature range, regardless of ambient temperatures, for safe and efficient use. Typical batteries are heavy. And, assembling a battery from a large battery array, that include a large number of individual cells, takes significant amount of manufacturing time.

Additionally, vehicles have limited space, weight carrying capacity, and a wide range of operating temperatures, there is a need to have a battery configuration which minimizes occupied space, is temperature controlled, minimizes weight, and minimizes manufacturing time.

### BRIEF SUMMARY OF THE INVENTION

A thin floor battery layer for a vehicle, the thin floor battery layer comprising: an upper layer; a lower layer; a frame, the frame comprising of: a plurality of pockets; a duct system, including a main duct and a plurality of capillary ducts; a plurality of bus bars; and at least one mounting plate; wherein the frame is between the upper lay and the lower layer; wherein the frame holds a plurality of batteries; wherein the plurality of pockets are underneath the plurality of batteries; and wherein air passes through the duct system via the main duct and into the plurality of capillary ducts that feed the plurality of pockets so as to cool the plurality of batteries.

Wherein the lower layer is fastened on top of a vehicle frame, wherein the vehicle frame comprises a valley on top of at least one hollow rib. Wherein the main duct system is fed air from the vehicle frame; wherein air travels along the valley of the at least one hollow rib into the main duct via an aperture in at least one of the lower layer and the frame. Wherein the valley of the at least one hollow rib is connected to an air duct from an air conditioner or heater unit.

And, wherein the at least one mounting plate is bolted to a bracket that is wrapped around the frame, wherein the mounting plate has a plurality of apertures designed to hold mounting bolts for mountable items.

### BRIEF DESCRIPTION OF THE DRAWINGS

FIG. 1 is an isometric view of a thin floor battery layer.

FIG. 2 is a top oriented isometric view of the thin floor battery layer showing a plurality of pockets.

FIG. 3 is a side sectional view as referenced in FIG. 1 at AA of the thin floor battery layer and a vehicle frame.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this application will be thorough and complete, and will fully convey the true scope of the invention to those skilled in the art.

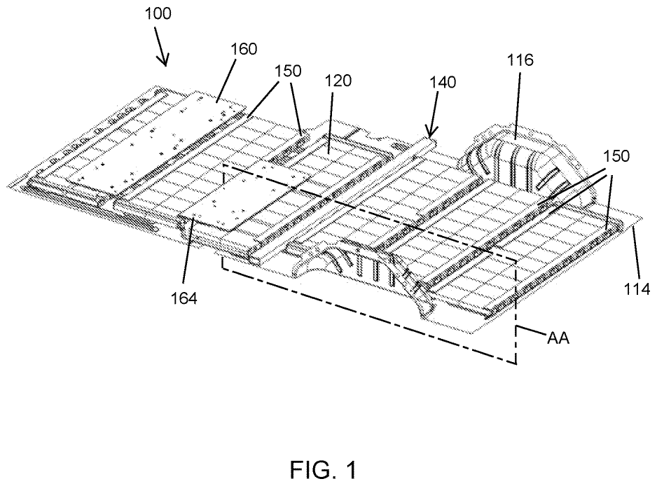

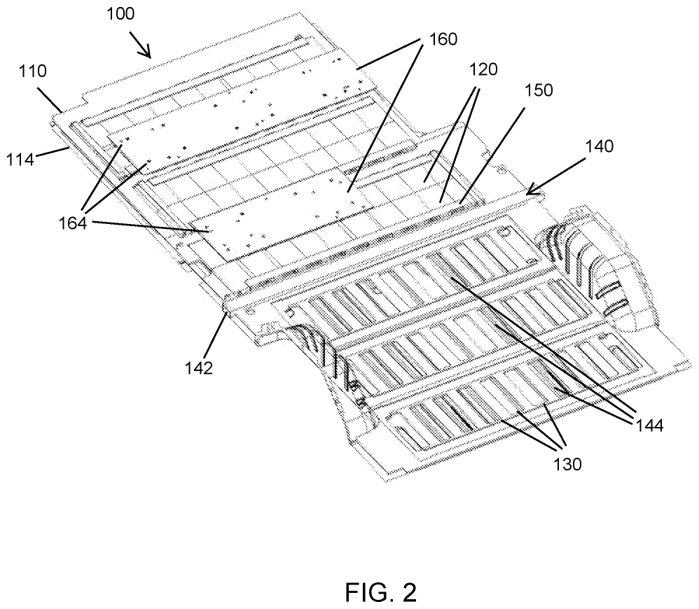

As seen in FIGS. 1-3, a thin floor battery layer 100 may include a frame 110, an upper layer 112 (not shown), and a lower layer 114. The thing floor battery layer 100 may hold a plurality of batteries 120. In most embodiments, the thin floor battery layer 100, including the frame 110, the upper layer 112, and the lower layer 114, may be made up of at least one of a metal, plastic, and composite materials. In most embodiments, the frame 110, the upper layer 112, and the lower layer 114 may be connected together with permanent fasteners, such as adhesives, welding, riveting, etc., or non-permanent fasteners, such as screws, bolts and nuts, clamps, clips, brackets, etc., or a combination thereof

In all embodiments, the thin floor battery layer 100 may be constructed to withstand an interior weight, such as at least one of occupants, seats, cargo, furniture and appliances (i.e., cabinets, beds, sofas, tables, stove, fridges, showers, toilets, tubs, water heaters, fryers, heaters, air conditioners), bicycles, small-sized motorized vehicles, etc. In most embodiments, the frame 110 may be designed to evenly support weight that may be applied to the upper layer 112 of the thin floor battery layer 100.

In most embodiments, the thin floor battery layer 100 may sit on top of a vehicle frame 15 of a vehicle 10. In most embodiments, the thin floor battery layer 100 may be one inch thick to maximize an interior space of a vehicle 10. In other embodiments, the thin floor battery layer 100 may be any thickness to accommodate various sizes of batteries. In most embodiments, the thin floor layer 100 may be constructed to minimize weight so as to reduce an overall weight of the vehicle 10 and may increase a maximum usable volume within the vehicle 10, which may extend the life of the engine of the vehicle 10.

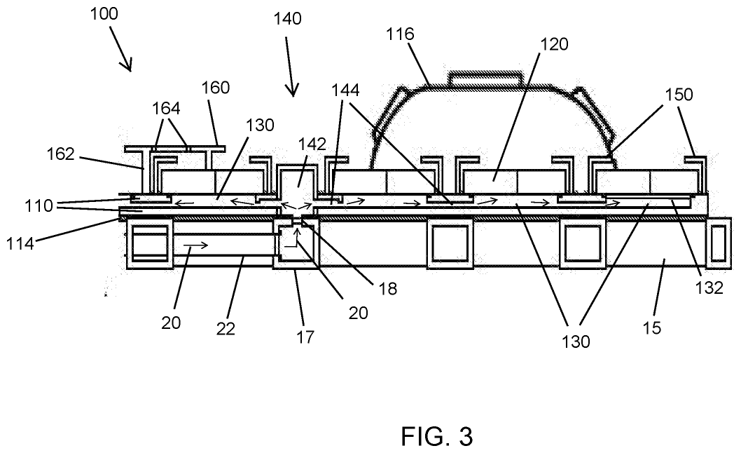

In some embodiments, the thin floor battery layer 100 includes pockets 130 in the frame 110. In most embodiments, the pockets 130 in the frame 110 may be used for air 20 so as to thermo-regulate the plurality of batteries 120. In most embodiments, the pockets 130 may be positioned in the frame 110 so as to apply cooled or heated air 20 on multiple batteries 120 at once. In some embodiments, each pocket 130 may be positioned in the frame 110 so as to correspond to a single battery of the plurality of batteries 120. In most embodiments, the pockets 130 may be sized to provide adequate air flow to the plurality of batteries 120. In some embodiments, the pockets 130 may contain filters 132 (one filter 132 is shown in FIG. 3 for illustrative purposes, but the filters 132 may be in as many pockets 130 as desired) so as to prevent dust from building up on the plurality of batteries 120, which may result in poor convection properties.

In most embodiments, the air 20 may be heated and/or cooled depending on the necessary temperature range required for the plurality of batteries 120. With regards to FIG. 3, arrows represent the air 20 that may flow through the thin floor battery layer 100. In a preferred embodiment, the pockets 130 may be fed by a battery frame duct system 140 comprising a main duct 142 and a plurality of capillary ducts 144. In this embodiment, as seen in FIG. 3, the air 20 may be supplied to the main duct 142, which supplies the plurality of capillary ducts 144 that may feed into the pockets 130.

In most embodiments, the air 20 may come from the vehicle frame 15. In most embodiments, the air 20 may flow through a valley 16 of at least one hollow rib 17 of the vehicle frame 15. In most embodiments, the valley 16 of the at least one hollow rib 17 may be a depression or indentation in a top of the at least one hollow rib 17. When the lower layer 114 of the thin floor battery layer 100 rests on the vehicle frame 16, the lower layer 114 and the valley 16 of the at least one hollow rib 17 may create an air pathway 21 along the at least one hollow rib 17 of the vehicle frame 15.

In most embodiments, the valley 16 of the at least one hollow rib 17 may run longitudinal, latitudinal, or in any direction in comparison to the vehicle frame 15, which may be entirely dependent on a model of the vehicle 10. The direction of the valley 16 of the at least one hollow rib 17 in FIG. 3 is for illustrative purposes only and not a limitation of the described invention. In some embodiments, the valley 16 of the at least one hollow rib 17 may be connected to the main duct 142 via an air aperture 118, as seen in FIG. 3. In other embodiments, each of the valley 16 of the at least one hollow rib 17 may be connected directly to a group of the pockets 130 or directly to the capillary ducts 144 via a plurality of air apertures 119. In some embodiments, the air 20 may be controlled separately through different valleys 16 of the hollow ribs 17. In most embodiments, the air 20 may be used to control the temperature of the thin floor battery layer 100 and the plurality of batteries 120. In some embodiments, the user may control the temperature of the thin floor battery layer 100 through a vehicle console.

In some embodiments, the air 20 may be supplied by the vehicle 10, such as an air conditioning unit and/or heater. In some embodiments, the air conditioning unit and/or heater of the vehicle 10 may have at least one of a heated and cooled air duct 22 directly connected to the valley 16 of the at least one hollow rib 17 of the vehicle frame 15 so as to best direct the air 20 into the battery frame duct system 140 and/or the pockets 130 of the thin floor battery layer 100.

In other embodiments, the air 20 may be supplied by a separate auxiliary heating and cooling system 23 (not shown) installed on the vehicle 10. The separate auxiliary heating and cooling system 23 may be connected to at least one of the battery frame duct system 140 (typically via the main duct 142) of the thin floor battery layer 100, the vehicle frame 15, the valley 16 of the at least one hollow rib 17, and at least one of the pockets 130 via the at least one of the heated and cooled air ducts 22. The separate auxiliary heating and cooling system 23 may allow a user to install said system 23 closer to the thin floor battery layer 100, thus creating a more efficient heat/cooling system, as well as reducing wear and tear on the vehicle 10 air conditioning unit and/or heater. In this embodiment, the separate auxiliary heating and cooling system 23 may be controlled independently from the vehicle console.

In most embodiments, the thin floor battery layer 100 may contain a bus bar 150 that may be designed to hold the plurality of batteries 120. The bus bar 150 may assist in the placement of the plurality of batteries 120, so as to save space, time, money, and weight. The bus bar 150 may also increase installation speed and reduce error during installation.

In some embodiments, the bus bar 150 may organize the plurality of batteries 120 so that at least one mounting plate 160 may be installed on to the frame 110 of the thin floor battery layer 100. In most embodiments, the mounting plate 160 may be attached to the frame 110 via at least one mounting leg 162. In most embodiments, the mounting leg 162 may be attached to at least one of the frame 110 and the lower layer 114 using permanent fasteners, non-permanent fasteners, or a combination thereof as listed above. In a preferred embodiment, the mounting leg 162 may be fastened through the frame 110 and the lower layer 114 on to the vehicle frame 15, using at least one bracket 163 that may be wrapped around the at least one hollow rib 17 of the vehicle frame 15. The mounting leg 162 may then be bolted to the at least one bracket 163. The fasteners are not shown in the figures for clarity. In some embodiments, the mounting plate 160 may be fastened to the upper layer 114.

In most embodiments, the mounting plate 160 may have a plurality of apertures 164 for mounting at least one mountable item (not shown), such as furniture (including a seat, a bench, a bed, a couch, a table, a dresser, a cabinet, etc.), appliances (including a fridge, a stove, a shower, a toilet, etc.), and fixtures. In most embodiments, the plurality of apertures 164 may be threaded to receive at least one mounting bolt from the at least one mountable item. Thus, the at least one mounting plate 160 may allow for modular mounting items that may be arranged by the user depending on the user's desires or needs when using the vehicle.

In most embodiments, the plurality of apertures 164 may be designed to allow the at least one mounting bolt to pass around or between the plurality of batteries 120, so to prevent the at least one mounting bolt from damaging or moving the plurality of batteries 120. Thus, the thin floor battery layer 100 may maintain a slimer profile due to the decrease head-space required above the plurality of batteries 120. In some embodiments, the plurality of apertures 164 may be various sizes to accommodate different sizes of bolts, thus keying some of the at least one mountable items to different areas of the thin floor battery layer 100.

In some embodiments, the lower layer 114 of the thin floor battery layer 100 may have at least one wheel well 116. In these embodiments, the at least one wheel well 116 may be molded from the lower layer 114 so as to match an existing wheel well (not shown) on the vehicle 10. In other embodiments, the at least one wheel well 116 may be removably attachable to the frame 110. The at least one wheel well 116 may be made from the same material as at least one of the frame 110, the upper layer 112, and the lower layer 114. In those embodiments, the at least one wheel well 116 may be used to secure the thin floor battery layer 100 within a body of the vehicle 10. The at least one wheel well 116 may be used instead of the fasteners described above so at to decrease the time needed to remove and or replace the thin floor battery layer 100 in the vehicle 10, as desired by the user.

In most embodiments, standard maintenance of the thin floor battery layer 100 may be completed with standard tools known by one reasonably skilled in the art. In some embodiments, the thin floor battery layer 100 may be made of one or more pieces or sections 105, thus allowing the thin floor battery layer 100 to be taken apart for easy storage, cleaning, and shipping.

In particular, with respect to the above description, it is to be realized that the optimum dimensional relationships for the parts of the present invention may include variations in size, materials, shape, form, function and manner of operation. The assembly and use of the present invention are deemed readily apparent and obvious to one skilled in the art.

1. A thin floor battery layer for a vehicle, the thin floor battery layer comprising:
an upper layer;
a lower layer;
a frame, the frame comprising of:
a plurality of pockets;
a duct system, including a main duct and a plurality of capillary ducts;
a plurality of bus bars; and
at least one mounting plate;
wherein the frame is between the upper lay and the lower layer;
wherein the frame holds a plurality of batteries;
wherein the plurality of pockets are underneath the plurality of batteries; and
wherein air passes through the duct system via the main duct and into the plurality of capillary ducts that feed the plurality of pockets so as to cool the plurality of batteries.

2. The thin floor battery layer of claim 1, wherein the lower layer is fastened on top of a vehicle frame, wherein the vehicle frame comprises a valley on top of at least one hollow rib.

3. The thin floor battery layer of claim 2, wherein the main duct system is fed air from the vehicle frame; wherein air travels along the valley of the at least one hollow rib into the main duct via an aperture in at least one of the lower layer and the frame.

4. The thin floor battery layer of claim 3, wherein the valley of the at least one hollow rib is connected to an air duct from an air conditioner or heater unit.

5. The thin floor battery layer of claim 1, wherein the duct system is connected to an air conditioning or heater unit controlled by the vehicle.

6. The thin floor battery layer of claim 1, wherein the duct system is connected to an auxiliary air conditioning or heater unit not controlled by the vehicle.

7. The thin floor battery layer of claim 1, wherein the at least one mounting plate is bolted to a bracket that is wrapped around the frame, wherein the mounting plate has a plurality of apertures designed to hold mounting bolts for mountable items.

8. The thin floor battery layer of claim 7, wherein the bus bar holds the plurality of batteries; wherein the bus bar is design to allow for gaps or space for the mounting bolts.

9. The thin floor battery layer of claim 7, wherein the mountable items include at least one of a seat, a bench, a bed, a couch, a table, a dresser, a cabinet, a fridge, a stove, a shower, and a toilet.

10. The thin floor battery layer of claim 1, wherein the lower layer has wheel wells that secured the thin floor battery layer to the vehicle.
